(19) United States
(12) Patent Application Publication
(10) Pub. No.: US 2023/0009420 A1
(43) Pub. Date: Jan. 12, 2023

(54) PRESS WITH ELECTRICAL TOGGLE LINKAGE AND ELECTRIC LINEAR ACTUATOR

(71) Applicant: RFB Associates, Inc. dba Bruno Associates, Scotia, NY (US)

(72) Inventors: Sean Patrick Bruno, SR., Altamont, NY (US); Robert Francis Bruno, SR., Altamont, NY (US)

(21) Appl. No.: 17/654,677

(22) Filed: Mar. 14, 2022

Related U.S. Application Data
(60) Provisional application No. 63/219,884, filed on Jul. 9, 2021.

(51) Int. Cl. B30B 1/10; H02K 41/02; B30B 1/42

(52) U.S. Cl. CPC B30B 1/10; H02K 41/02; B30B 1/42

(57) ABSTRACT

A press includes a horizontal electric linear actuator; a stationary upper frame; a press travel plate; and a press toggle linkage. The press toggle linkage is connected to the stationary upper frame and to the electric linear actuator to move the press travel plate vertically.

This application claims priority from U.S. Provisional Patent Application No. 63/219,884 filed Jul. 9, 2021, entitled “Press With Electrical Toggle Linkage And Electric Linear Actuator,” the entire contents of which are incorporated by reference.

### TECHNICAL FIELD

The disclosure relates generally to a press or die cutting machine for cutting materials. More particularly, the disclosure relates generally to a die cutting machine or press for cutting materials with an electrically actuated toggle linkage system.

### BACKGROUND

Materials including metallic and non-metallic materials in various forms that may include sheets or rolls of materials, such as foam, sheets of rubber, items made from paper, paperboard, cardboard (puzzles), or corrugated paperboard; seals of various materials, sheet metal and other materials have been cut from sheets or rolls of stock “raw” materials. Often, the cutting process is a complex process that may require that the sheets be processed individually.

Conventional die cutting machines or presses are known to move a travel plate toward and from material to be cut. The travel plate is provided with a cutting die on a surface juxtaposed over the material to be cut. One or more vertically or horizontally-oriented pistons, such as pneumatic/hydraulic actuated pistons, lower and raise the travel plate with its cutting die. Accordingly, movement of the travel plate is reciprocal in a generally vertical direction from above the material, down through the material. Movement of the travel plate with its cutting die continues until the cutting die of the travel plate contacts or abuts a base that supports the materials to be cut and/or controls of the conventional die cutting machine or press stops the movement in the downward vertical movement.

The vertical orientation of pistons, such as pneumatic/hydraulic actuated pistons, inherently limit use and locations where such a pneumatic/hydraulic actuated piston press can be used. First, there must be adequate vertical overhead for a vertically orientated pneumatic/hydraulic actuated piston. The pressure that vertically orientated pneumatic/hydraulic actuated pistons exert on the material and thus the base plate is often constant. Accordingly, under such a constant pressure, it may be difficult to accurately control the extent of cutting, known as “kiss cutting” (for example for peel off stickers, scored items intended to remain with but be easily separated from their stock material, and similar, for example but not limited to, where cutting completely through the stock material is not desired). The inexact extent of pneumatic/hydraulic actuated piston movement may occur even with control systems that are constantly monitored.

Additionally, vertically orientated pneumatic/hydraulic actuated pistons are also limiting in terms of maintenance, upkeep, materials, and operational support. The pneumatic/hydraulic will require change out of pneumatic/hydraulic fluid after a set amount of use. Storage of pneumatic/hydraulic fluid will require extra facility space, where square footage may be costly. Also, concerns of spillage of pneumatic/hydraulic fluids must be addressed and mitigation/remediation plans in place, known and possibly approved by regulatory agencies.

Another aspect of pneumatic/hydraulic actuated pistons, these pneumatic/hydraulic actuated pistons are not easily exchanged in case one pneumatic/hydraulic actuated piston fails. Fluid lines will need to be drained, spillage contained, and possibly a spare pneumatic/hydraulic actuated pistons installed, primed with pneumatic/hydraulic fluids. Only after installing, priming, and piston initiation would pneumatic/hydraulic actuated pistons actually start to be used for cutting. Thus, pneumatic/hydraulic actuated pistons that are vertically oriented may not be desirable in some instances.

### BRIEF DESCRIPTION

All aspects, examples and features mentioned below can be combined in any technically possible way.

An aspect of the disclosure provides a press that includes a horizontal electric linear actuator; a stationary upper frame; a press travel plate; and a press toggle linkage; wherein the press toggle linkage is configured to connect to the stationary upper frame, press travel plate, and also connects to the horizontal electric linear actuator to move the press travel plate vertically.

Another aspect of the disclosure includes any of the preceding aspects, the press toggle linkage includes an over center mechanism configuration to move the press travel plate.

Another aspect of the disclosure includes any of the preceding aspects, wherein the press toggle linkage includes at least one center joining link; at least one upper toggle arm; and at least one lower toggle arm, wherein the at least one upper toggle arm and the at least one lower toggle arm are configured to connect to the at least one center joining link.

Another aspect of the disclosure includes any of the preceding aspects, wherein the at least one center joining link includes a plurality of center joining links, the at least one upper toggle arm includes a plurality of upper toggle arms; and the at least one lower toggle arm includes a plurality of lower toggle arms.

Another aspect of the disclosure includes any of the preceding aspects, wherein the at least one upper toggle arm and the at least one lower toggle arm that are configured to connect to the at least one center joining link are configured to pivotally connect to the at least one center joining link.

Another aspect of the disclosure includes any of the preceding aspects, wherein the at least one upper toggle arm and the at least one lower toggle arm are configured to pivotally connect to the at least one center joining link by toggle pins.

Another aspect of the disclosure includes any of the preceding aspects, wherein the horizontal electric linear actuator includes a rod housing and a piston rod, wherein the piston rod is configured to connect to the press toggle linkage.

Another aspect of the disclosure includes any of the preceding aspects, wherein the piston rod is configured to pivotally connect to the press toggle linkage at an actuator attachment yoke.

Another aspect of the disclosure includes any of the preceding aspects, wherein the horizontal electric linear actuator is configured to mount to the stationary upper frame at an actuator trunnion mount, and the horizontal electric linear actuator is configured to pivot in angle α around the actuator trunnion mount during horizontal movement of the horizontal electric linear actuator.

Another aspect of the disclosure includes any of the preceding aspects, wherein the press toggle linkage is configured to provide a variable force to the press travel plate.

Another aspect of the disclosure includes any of the preceding aspects, wherein the variable force may be at least about 36 ton-force (about 80,000 pound force) and could be at least 40 ton-force.

Two or more aspects described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 illustrates a schematic isometric view of a die cutting machine or press for cutting materials with an electrically actuated toggle linkage system according to embodiments of the disclosure;

FIG. 2 illustrates a schematic isometric view of a die cutting machine or press for cutting materials with an electrically actuated toggle linkage system at a retracted position to start a cut cycle according to embodiments of the disclosure;

FIG. 3 illustrates a schematic isometric view of a die cutting machine or press for cutting materials with an electrically actuated toggle linkage system at a midpoint or center position in the cut cycle according to embodiments of the disclosure;

FIG. 4 illustrates a schematic isometric view of a die cutting machine or press for cutting materials with an electrically actuated toggle linkage system at a fully extended position after a complete cut cycle according to embodiments of the disclosure;

FIG. 5 illustrates a schematic isometric view of a die cutting machine or press for cutting materials with an electrically actuated toggle linkage system at a fully extended position after a complete cut cycle with the head of the press adjusted fully down, according to embodiments of the disclosure;

FIG. 6 illustrates a schematic isometric view of an electrically actuated toggle linkage system, according to embodiments of the disclosure

FIG. 7 illustrates a schematic isometric view of an electric press system with the linear actuator at a fully extended position after a complete cut cycle with the head of the press adjusted fully down, according to embodiments of the disclosure;

FIG. 8 illustrates a schematic isometric view of an electric press system with the linear actuator at a fully extended position after a complete cut cycle with the head of the press adjusted fully up, according to embodiments of the disclosure;

FIG. 9 illustrates the linear actuator and toggle system for a die cutting machine or press for cutting materials with an electrically actuated toggle linkage system, according to embodiments of the disclosure;

FIG. 10 illustrates a phantom schematic isometric view of a die cutting machine or press for cutting materials with an electrically actuated toggle linkage system according to embodiments of the disclosure;

FIG. 11 is a graph of force and motion of a die cutting machine or press for cutting materials with an electrically actuated toggle linkage system and actuator position, according to embodiments of the disclosure; and

FIGS. 12A and 12B illustrate schematic isometric views of a die cutting machine or press for cutting materials in the vertically movable press travel plate raised position (FIG. 12A) and in the vertically movable press travel plate lower position (FIG. 12B) with an electrically actuated toggle linkage system where the electronic actuator is vertically oriented according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the subject matter of the current disclosure, it will become necessary to select certain terminology when referring to and describing relevant machine components within a die cutting machine or press for cutting materials, and in particular a die cutting machine or press for cutting materials with an electrically actuated toggle linkage system. To the extent possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, “vertical” and “horizontal” are terms that indicate a direction relative to the figures herein. The terms “above” and “below” are used with reference to orientations of elements with respect to each other. The terms “left” and “right” are used with reference to orientations of elements in the figures with respect to each other provided to facilitate description of features as embodied by the disclosure, and are not intended to limit the embodiments in any manner.

In addition, several descriptive terms may be used regularly herein, as described below. The terms “first”, “second”, and “third” may be used interchangeably to distinguish one component from another and are not intended to signify location or importance of the individual components.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components but do not preclude the presence or addition of one or more other features, integers, steps, operations, elements, components, and/or groups thereof. “Optional” or “optionally” means that the subsequently described event or circumstance may or may not occur or that the subsequently describe component or element may or may not be present, and that the description includes instances where the event occurs, or the component is present and instances where it does not or is not present.

Where an element or layer is referred to as being “on,” “engaged to,” “connected to” or “coupled to” another element or layer, it may be directly on, engaged to, connected to, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As indicated above, the disclosure provides an electric driven linear actuator for a die cutting machine or press (hereinafter “press”). Technical effects for the press include an electrically actuated linear actuator and press toggle linkage attached to the electrically actuated linear actuator. The press, as embodied by the disclosure, does not require a hydraulic power unit or oil for lubrication. The press can cut many materials and the materials can be provided in many forms, including sheets of material, roll of material, or materials provided in any other format.

Feed systems for the press, as embodied by the disclosure, can include at least one of a belt feed system cutting on urethane, nylon, polypropylene, and steel. In another aspect of the embodiments, feed systems for the press can include at least one of a roll feed system cutting on urethane, nylon, polypropylene, and steel. In a further aspect of the embodiments, feed systems for the press can include at least one of a clamp feed system also cutting on urethane, nylon, polypropylene, and steel. Additionally, another aspect of the embodiments, feed systems for the press can include at least one of a sliding tray feed system cutting on urethane, nylon, polypropylene, and steel.

As embodied by the disclosure, tonnage for the press can be in a range between about 9 metric tons (about 10 US tons) or less if desired, and up to about 450 metric tons (about 500 US tons) or more if desired. As embodied by the disclosure, tonnage for the press can be 500 metric tons (about 550 US tons). Further, if dual actuators are provided as embodied by the disclosure, tonnage for the press can be at least 1500 metric tons (about 1650 US tons). The press can employ steel rule cutting dies with a range between about 2.0 cm to about 11.0 cm (0.75 inches to 4 inches).

The press, as embodied by the disclosure can operate to:
Die cut non-metallic and metallic materials;
Die cut seal materials;
Emboss with heat and pressure materials;
Die cut and score materials; and
Use heating platens on materials.

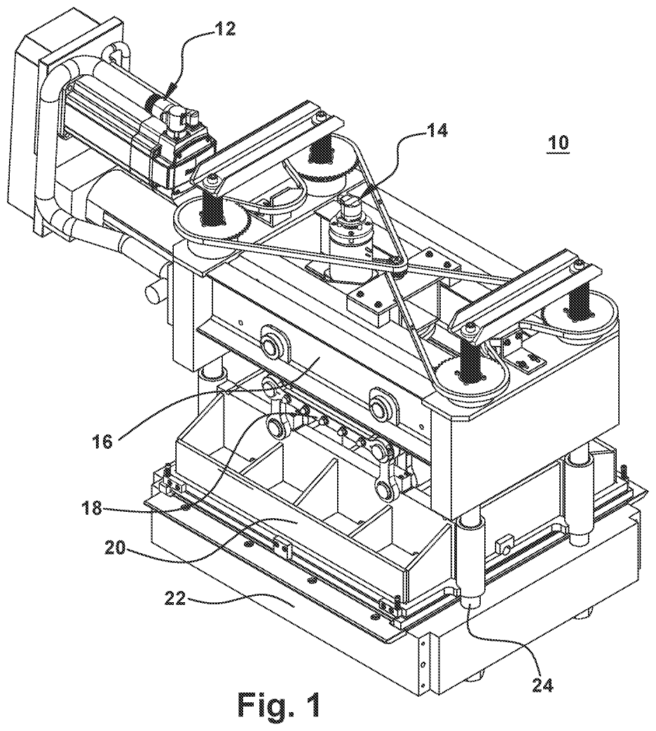

FIG. 1 illustrates a die cutting machine or press 10 (hereinafter “press 10”) with an electrically actuated linkage. Press 10 includes a horizontal electric linear actuator 12 for movement of press toggle linkage 18 that provides press 10 with an over center mechanism configuration to move a vertically movable press travel plate 20 that includes a cutting die (not illustrated for ease of illustration). Press toggle link 12 will be described hereinafter in more detail.

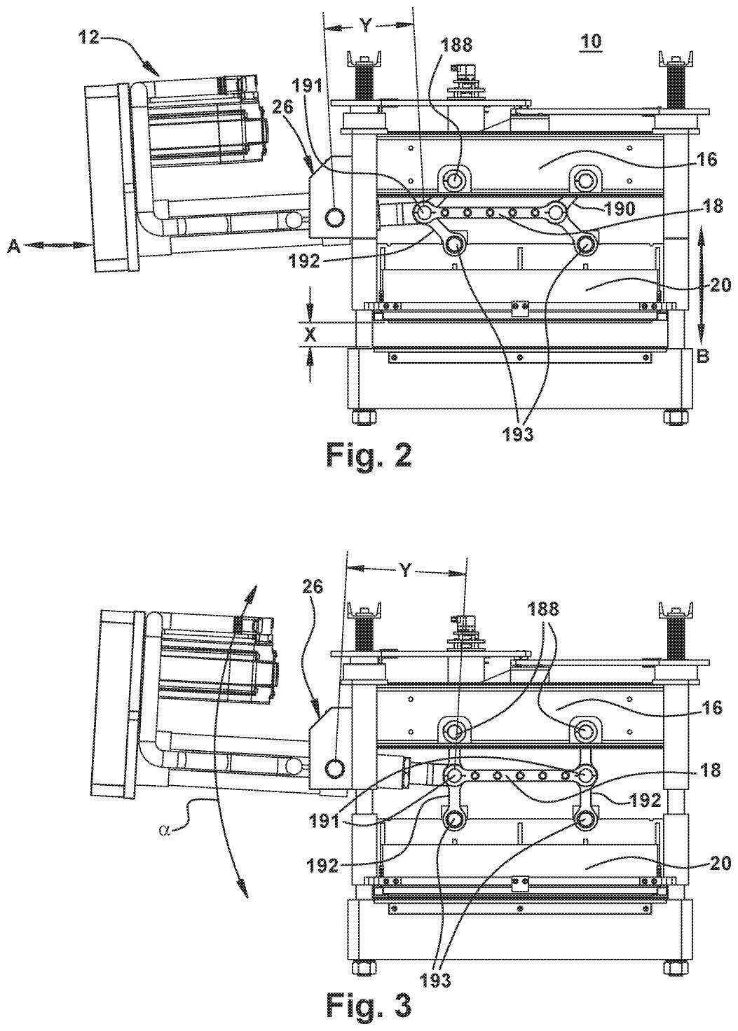

Press 10 further includes a stationary upper frame 16 and the vertically movable press travel plate 20. When horizontal electric linear actuator 12 moves press toggle linkage 18, press toggle linkage 18 will be moved in a first direction A (see FIG. 2) and will cause reciprocation of press travel plate 20 in direction B.

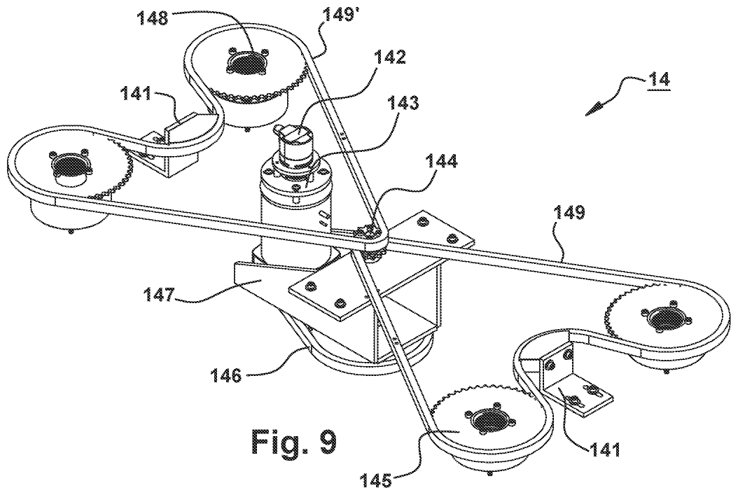

Press 10 additionally includes a head adjustment system 14, which will be described here and after with respect to FIG. 9.

Press travel plate 20 includes a cutting die on its bottom side. Cutting die in press travel plate 20, which can be configured to cut material into various shapes and configurations, will engage a material to be cut that may be disposed on press base 22. The material to be cut, in certain aspects of the embodiments, can be single sheets of material, and elongated roll(s) of material, or any other material that may be placed under press travel plate 20 and cutting die.

Press 10 also include alignment rods 24. Alignment rods 24 are configured to permit and contain the reciprocating motion of press travel plate 20. Movement of press travel plate 20 is reciprocal travel in direction B (FIG. 2).

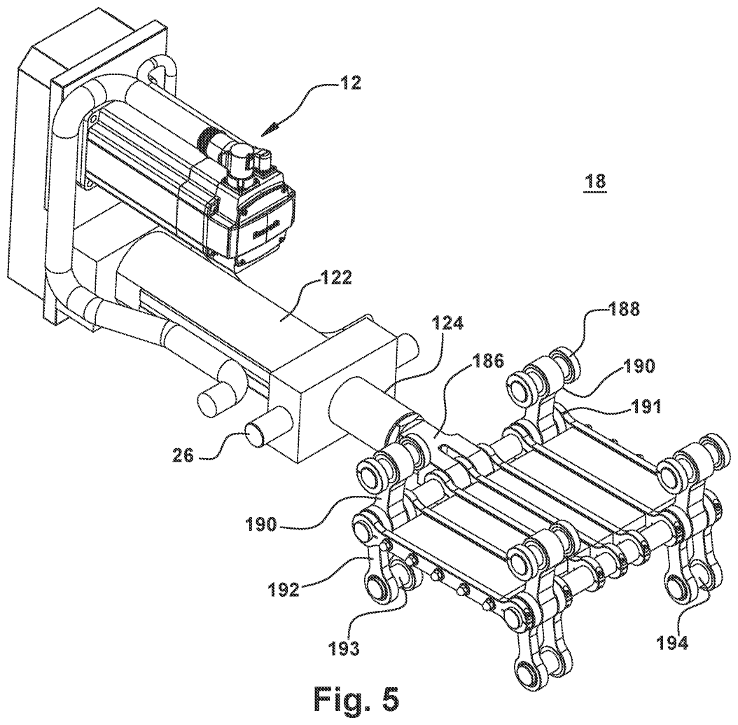

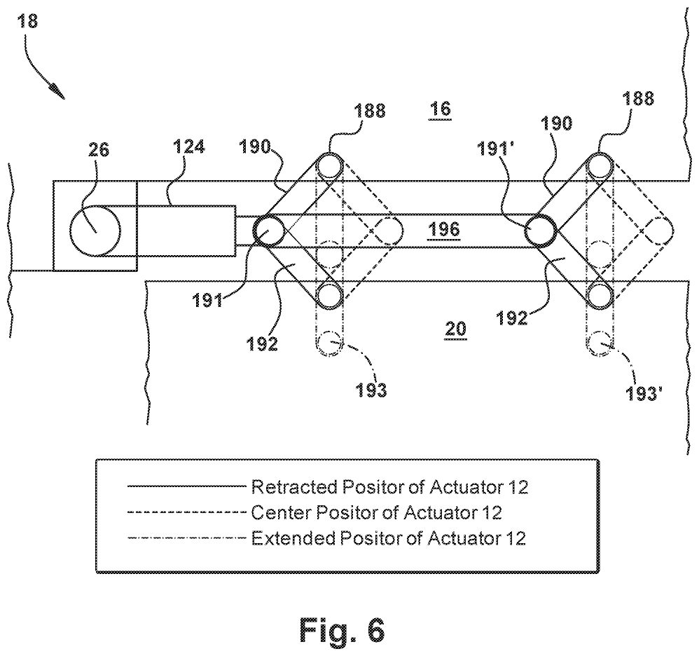

With reference to FIGS. 2-4, as horizontal electric linear actuator 12 moves press toggle linkage 18, which is best visible in FIGS. 5 and 6 and be described hereinafter, and press travel plate 20 reciprocate in direction B. Accordingly, press travel plate 20 reciprocates toward and away in opening X in which material to be cut is disposed. When press plate 20 is moved to its downward position as in FIG. 3, cutting die disposed on the bottom of press travel plate 20 engages and cuts some material. An extent of reciprocation of press travel plate 20 is designated by the operator of the press 10. In one aspect of the embodiment, press travel plate 20 (and its associated cutting die) is configured to cut all the way through material disposed on base plate 22. In another non-limiting aspect of the embodiment, press travel plate 20 and its associated cutting die is configured to travel partially through the material disposed on press base 22 to an operator designated degree through the material. This operator-designated degree of press travel plate 20 and its associated cutting die may be beneficial if the material was not intended to be fully separated from the surrounding material, such as a sticker, seal, gasket, or the like.

FIG. 2 illustrates press 10 with horizontal electric linear actuator 12 in the furthest retracted position, which in FIG. 2 is to the left-most position of horizontal electric linear actuator 12. When the horizontal electric linear actuator 12 is activated, piston 124 is moved to the right in the figures, as in FIG. 3. In FIG. 3, actuator 20 and press toggle linkage 18 are at a “center” position with the press travel plate 20 disposed at its low or cutting position.

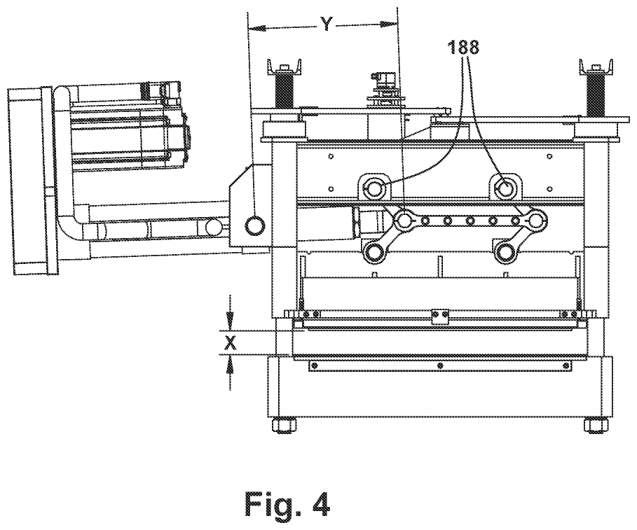

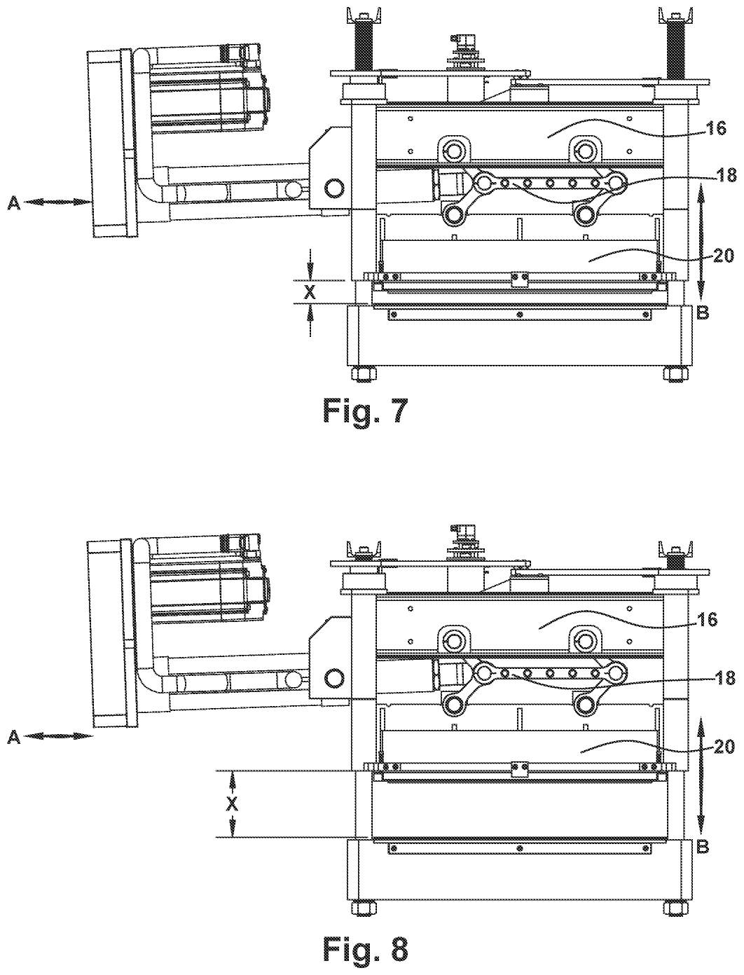

Further movement of the horizontal electric linear actuator 12 is illustrated in FIGS. 4, 7, and 8. Horizontal electric linear actuator 12 is in a fully extended position to its right in the FIG. 4. Accordingly, horizontal electric linear actuator 12 and press toggle linkage 18 brings press travel plate 20 to an elevated position with opening X in its raised position. The raised position is the same position press travel plate 20 is in FIG. 2 with press travel plate 20 and its cutting die separated by opening X from the material to be cut.

Accordingly, a full cut cycle has been complete. Any material under press travel plate 20 and its cutting die in the opening X can be removed, advanced, recut or further processed as desired. This process will be reversed with the horizontal electric linear actuator 12 and press toggle linkage 18 moving from right to left (from the position in FIG. 4 to the position in FIG. 3, and then ultimately to the position in FIG. 2). Thus, in the “reverse” movement, from the position in FIG. 4 to the position in FIG. 3, and then ultimately to the position in FIG. 2, when a next piece of stock material is disposed in opening X another cutting operation will be initiated. As the horizontal electric linear actuator 12 is moved to the left, press toggle linkage 18 will reach a position in which it moves toward press travel plate 20 and cutting die toward base plate 22 at their lowest position as in FIG. 3. There, press travel plate 20 and its cutting die of press 10 again cuts material in opening X. As the horizontal electric linear actuator 12 is moved further to the left as in the figures, to its fully retracted as in FIG. 2, the material underneath the press travel plate 20 and cutting die has been cut.

As embodied by the disclosure, a full cycle of horizontal electric linear actuator 12 is a forward motion from a start, fully retracted position in FIG. 2, to a fully extended position in FIG. 4, and then a return motion from the fully extended position in FIG. 4 to the original start or retracted position in FIG. 2. This cycle, as embodied by the disclosure, enables two cutting operations of material in opening X by the press travel plate 20 and its cutting die. Therefore, press 10 with the horizontal electric linear actuator 12 and press toggle linkage 18, as embodied by the disclosure, can enable twice the efficiency, speed, productivity, and results compared to a press with a vertically mounted actuator. In conventional die cutting machines with vertically mounted actuators, a fully cycle from start, fully retracted position, to a fully extended position, and then a return motion from the fully extended position to the original start position enables a single cutting operation. Vertically actuated actuators of conventional die cutting apparatus apply constant pressure on structure that moves a cutting die to cut material.

With reference to FIGS. 1-6, horizontal electric linear actuator 12 and press toggle linkage 18 will now be described. Horizontal electric linear actuator 12 is disposed horizontally so a horizontal linear movement moves press toggle linkage 18 and press travel plate 20 as described herein.

Horizontal electric linear actuator 12 includes a rod housing 122. Rod housing 122 includes a movable piston rod 124. Piston rod 124 reciprocates in direction A (FIG. 2) as horizontal electric actuator 12 moves in press 10. Piston rod 124 is pivotally connected to press toggle linkage 18 at actuator attachment yoke 186. Horizontal electric actuator 12 also includes an actuator trunnion mount 26.

Actuator trunnion mount 26 is stationary with respect to stationary upper frame 16 and attached to rod housing 122. However, actuator trunnion mount 26 allows for pivoting of horizontal electric linear actuator 12 where it is attached to stationary upper frame 16. Actuator trunnion mount 26 permits horizontal electric linear actuator 12 to pivot around at angle α with respect to stationary upper frame 16 as press toggle linkage 18 is extended. Pivoting of horizontal electric linear actuator 12 enables an overall vertical dimension of press toggle link 18 at pivot pins 191, 191′ to increase as pivot pins 191, 191′ align vertically at the “center” cutting position versus being at angles to each other at retracted or extended positions. See FIGS. 2-4 and FIG. 6.

With respect to FIGS. 5 and 6, press toggle linkage 18 includes upper toggle pins 188 that are fixedly disposed in stationary upper frame 16. Press toggle linkage 18 also includes lower toggle pins 193, 194 that are disposed on press travel plate 20. Upper toggle arms 190 connect upper toggle pins 188 to yoke toggle pins 191, 191′ through upper toggle arms 190. Furthermore, yoke toggle pins 191, 191′ are connected to lower toggle pins 193, 194 through lower toggle arms 192.

Press toggle linkage 18 further includes center joining links 196. Center joining links 196 connect upper toggle arms 190, yoke toggle pin 191 to yoke toggle pin 191. This configuration of press toggle linkage 18 provides an over center toggle arrangement to move press travel plate 20 first vertically downwardly and then upwardly when horizontal electric linear actuator 12 moves its retracted far left position to its extended far right position in the figures in a first half of the cycle of horizontal electric linear actuator 12. In a return movement of horizontal electric linear actuator 12 from its extended far right position to its retracted far left position, press toggle linkage 18 provides an over center toggle arrangement to move press travel plate 20 vertically downwardly and then upwardly in a second half of the cycle of horizontal electric linear actuator 12.

With horizontal electric linear actuator 12 in its fully retracted position (FIG. 2) opening X is capable of accepting stock material to be cut. Material to be cut is disposed on base plate 22. Horizontal electric linear actuator 12 is initiated and moves from a retracted far left position in FIG. 2 to its extended far right position in FIG. 4. Thus, as horizontal electric linear actuator 12 pivots through angle α, piston rod 124 is moved to the right as seen in FIGS. 2-4 and FIG. 6 Piston rod 124, being connected to attachment yoke 186 thus moves attachment yoke 186 to the right in the figures.

Movement of attachment yoke 186, which is connected to yoke toggle pin 191, permits movement of press toggle linkage 18 both vertically and horizontally. Vertical movement of Movement of press toggle linkage 18 is illustrated in FIGS. 2-4. Movement of yoke toggle pin 191 causes center joining link(s) 196 to move to the right in the figures. Upper toggle pins 188 are fixed in upper frame 16 and held stationary therein, but rotate and permit rotation, as noted herein. With the over center configuration of upper toggle arms 190, yoke toggle pin 191, lower toggle arms 192 rotate as 196 is extended from left to right in the figures. However, since upper toggle arms 190 rotate at upper toggle pins 188, as 196 moves to the right, yoke toggle pins 191, 191′ move to the right, but will also move pivot about upper toggle pins 188. Thus, yoke toggle pins 191, 191′ vertically move forcing press travel plate 20 to also move vertically on press main rods 24. Accordingly, cutting die on press travel plate 20 can engage the material to be cut. This cutting position is illustrated in FIG. 3.

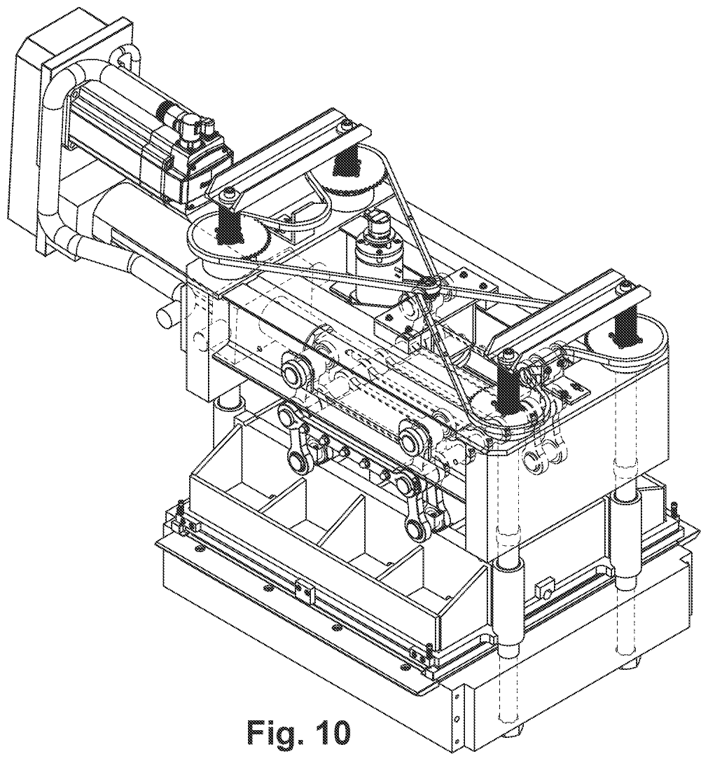

Press 10, as embodied by the disclosure, uses the press toggle linkage 18 to develop graduated and increasing cutting forces. This graduated and increasing cutting force output by the press toggle linkage 18 arises, in part, from the over center toggle action of press toggle linkage 18. As embodied by the disclosure, a graduated and increasing cutting force output is illustrated in FIG. 10 in an exemplary, illustrative, and non-limiting characterization. The graduated and increasing cutting force can be continuously variable based on the position of the horizontal electric linear actuator 12 with respect to press toggle linkage 18 presuming a constant actuator force is applied by horizontal electric linear actuator 12. In another aspect of the embodiments, a graduated and increasing cutting force can be modified during each cycle of press 10 by varying horizontal electric linear actuator 12 with a suitable controller changing actuator force by horizontal electric linear actuator 12.

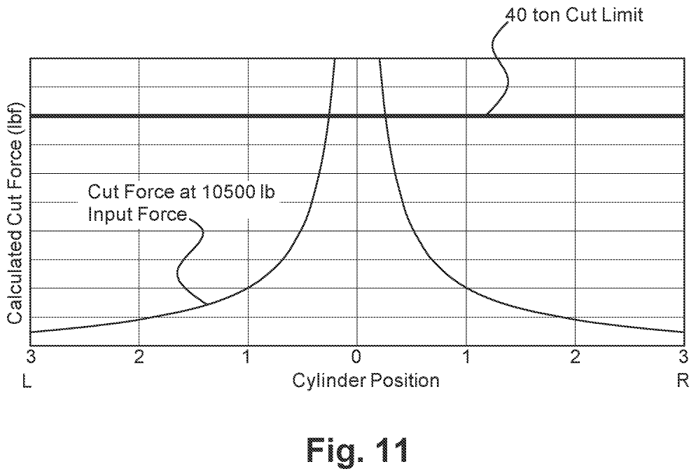

As illustrated in FIG. 11, as horizontal electric linear actuator 12 moves from the left to the right or from the fully retracted position “3” (L) on the left of the horizontal axis to position “3” on the right (R) of the horizontal axis, press travel plate 20 lowers. As press toggle linkage 18 reaches its fully extended “cutting” position or center (0) position (FIG. 3), the graduated and increasing cutting force applied by press 10 can reach a maximum cutting force. In FIG. 11, the center or “0” represents the fully disposed extended or cutting position of press travel plate 20 (FIG. 3). In FIG. 11, an illustrative and non-limiting at least about 36.3 ton-force (at least about 80,000 pound) cutting force is shown can be attained. As horizontal electric linear actuator 12 moves further to the right as in FIG. 4, graduated and increasing cutting force applied by press 10 is reduced.

Press plate 22 is configured to support the materials to be cut. In certain non-limiting aspects of the embodiment, press base 22 can include steel. In another non-limiting aspect of the embodiment, press base 22 can include a plastic cutting pad. Furthermore, aspects of the embodiments provide press base 22 to include an indexing cutting belt. Further configurations of base plate press base 22 are within the scope of the embodiment.

In certain aspects of the embodiments, one horizontal electric linear actuator 12 can be provided for press 10. In other aspects of the embodiments, more than one horizontal electric linear actuator 12 can be provided for press 10 to move press toggle linkage 18. More than one horizontal electric linear actuator 12 can enable forces in multiples of the number of horizontal electric linear actuators 12.

Press 10 is designed to cut materials of all configurations, densities, and harnesses. It can cut materials of multiple thicknesses as long as distance X is large enough. Press toggle linkage 18 enables press 10 to have a stroke that is essentially identical with every cycle. If desired, the cutting depth can be adjusted by moving head adjustment system 14, described here and after, to move upper frame 16 upper down, and direction B.

Press 10 includes a head adjustment system 14. Head adjustment system 14 permits movement of upper frame 16 in a vertical direction such as in direction B. Movement of upper frame 16 includes movement of upper toggle pins 188. Upper frame 16 moves vertically upwards, upper toggle pins 188 also move up. Further, movement of the upper toggle pins 188 given their connection through toggle system press toggle linkage 18 moves press travel plate 20 upward conversely movement of upper frame downward by the head adjustment system 14 will decrease the distance X by moving press travel plate 20 downward as in FIG. 2 direction B.

Head adjustment system 14 is an illustrative adjustment system for modifying the cutting distance X. In the illustrative and non-limiting head adjustment system 14, adjustment chains 149 are mounted on head main sprockets 145 and a jackshaft dual output 144, while being positioned around a chain tension brackets 141. Jackshaft dual output 144 is positioned on a mounting bracket 147 together with a gear motor 143 and a jackshaft reduction system 146. In this illustrative and non-limiting head adjustment system 14, if an operator of press 10 desires to modify the travel distance X, a signal is provided to operate gear motor 143 in either a clockwise or counterclockwise rotation. Thus, jackshaft dual output 144 will case stationary upper frame 16 to move vertically, either up or down, with respect to the remainder of press 10, thus modifying distance X.

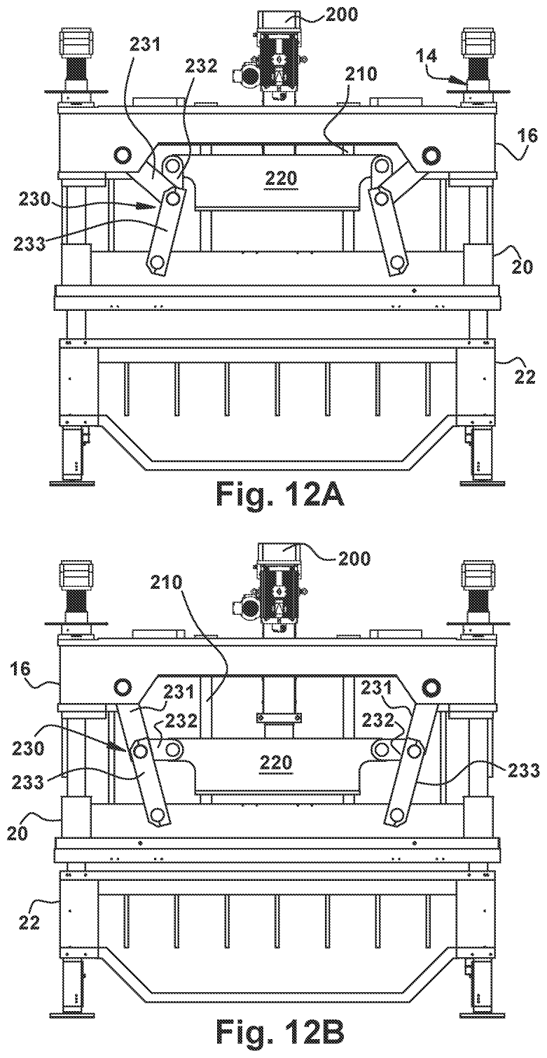

FIGS. 12A and 12B illustrate a schematic isometric view of a die cutting machine or press for cutting materials in the vertically movable press travel plate raised position (left figure) and in the vertically movable press travel plate lower position (right figure) with an electrically actuated toggle linkage system where the electronic actuator is vertically oriented. In FIGS. 12A and 12B like elements are provided like elements in the embodiments of FIGS. 1-11.

In the embodiment of FIGS. 12A and 12B, press 10 includes a vertically oriented electronic actuator 200 that is connected to a crosshead element 220 (“crosshead”). Linkage 230 includes three links, 231, 232, and 233, connected to stationary upper frame 16 and the vertically movable press travel plate 20. In the position in FIG. 12A (right side), linkage 230 is in a contracted position as electronic actuator 200 is in its un-extended position. With electronic actuator 200 in its extended position (FIG. 12B), linkage 230 is in a fully extended position that moves press travel plate 20 to a lowered/cutting position towards press base 22.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

What is claimed is:

1. A press, the press comprising:
an electric linear actuator, where the electronic linear actuator includes at least one of a horizontal linear actuator and a vertical linear actuator;
a stationary upper frame;
a press travel plate; and
a press toggle linkage;
wherein the press toggle linkage is configured to connect to the stationary upper frame and to the electric linear actuator to move the press travel plate vertically.

2. A press according to claim 1, wherein the press toggle linkage includes an over center mechanism configuration to move the press travel plate.

3. A press according to claim 1, wherein the press toggle linkage includes at least one center joining link; at least one upper toggle arm; and at least one lower toggle arm,
wherein the at least one upper toggle arm and the at least one lower toggle arm are configured to connect to the at least one center joining link.

4. A press according to claim 3, wherein the at least one center joining link includes a plurality of center joining links, the at least one upper toggle arm includes a plurality of upper toggle arms; and the at least one lower toggle arm includes a plurality of lower toggle arms.

5. A press according to claim 3, wherein the at least one upper toggle arm and the at least one lower toggle arms that are configured to connect to the at least one center joining link are configured to pivotally connect to the at least one center joining link.

6. A press according to claim 5, wherein the at least one upper toggle arm and the at least one lower toggle arms are configured to pivotally connect to the at least one center joining link by toggle pins.

7. A press according to claim 1, wherein the electric linear actuator includes a horizontal electric linear actuator and includes a rod housing and a piston rod, wherein the piston rod is configured to connect to the press toggle linkage.

8. A press according to claim 7, wherein the piston rod is configured to pivotally connect to the press toggle linkage at an actuator attachment yoke.

9. A press according to claim 1, wherein the electric linear actuator is a horizontal electric linear actuator and is configured to mount to the stationary upper frame at an actuator trunnion mount, and the horizontal electric linear actuator is configured to pivot in angle α around the actuator trunnion mount during horizontal movement of the horizontal electric linear actuator.

10. A press according to claim 1, wherein the press toggle linkage is configured to provide a variable force to the press travel plate.

11. A press according to claim 10, wherein the variable force may be at least about 36 ton-force (about 80,000 pound force).

12. A press according to claim 1, wherein the electric linear actuator is a vertical electric linear actuator and is configured to mount to the stationary upper frame at an actuator trunnion mount, and the vertical electric linear actuator is configured to reciprocate the press toggle link during vertical movement of the vertical electric linear actuator.

13. A press according to claim 12, wherein the vertical electric linear actuator is connected to a crosshead element to reciprocate the press toggle link during vertical movement of the vertical electric linear actuator.

14. A press according to claim 12, wherein the press toggle linkage includes an over center mechanism configuration to move the press travel plate.

15. A press according to claim 12, wherein the press toggle linkage includes at least one center joining link; at least one upper toggle arm; and at least one lower toggle arm,
wherein the at least one upper toggle arm and the at least one lower toggle arm are configured to connect to the at least one center joining link.

16. A press according to claim 15, wherein the at least one center joining link includes a plurality of center joining links, the at least one upper toggle arm includes a plurality of upper toggle arms; and the at least one lower toggle arm includes a plurality of lower toggle arms.

17. A press according to claim 15, wherein the at least one upper toggle arm and the at least one lower toggle arms that are configured to connect to the at least one center joining link are configured to pivotally connect to the at least one center joining link.

18. A press according to claim 17, wherein the at least one upper toggle arm and the at least one lower toggle arms are configured to pivotally connect to the at least one center joining link by toggle pins.

19. A method moving an electric linear actuator of a press, the press including an electric linear actuator, where the electronic linear actuator includes at least one of a horizontal linear actuator and a vertical linear actuator; a stationary upper frame; a press travel plate; and a press toggle linkage;
method comprising the electric linear actuator moving the press travel plate vertically wherein the press toggle linkage is configured to connect to the stationary upper frame and to.

20. A method according to claim 19, wherein the press toggle linkage includes an over center mechanism configuration to move the press travel plate.
